(19) United States
(12) Patent Application Publication
(10) Pub. No.: US 2026/0239341 A1
(43) Pub. Date: Aug. 13, 2026

(54) REPORTING OF CONFIGURED GRANT OCCASIONS

(71) Applicant: Nokia Technologies Oy, Espoo (FI)

(72) Inventors: Margarita GAPEYENKO, Espoo (FI); Zexian LI, Espoo (FI); Stefano PARIS, Vanves (FR); Chunli WU, Beijing (CN); Jorma Johannes KAIKKONEN, Oulu (FI)

(21) Appl. No.: 19/151,697

(22) PCT Filed: Feb. 24, 2023
(86) PCT No.: PCT/CN2023/078270

§ 371 Date: Jul. 29, 2025

(51) Int. Cl. H04W 72/1273; H04L 5/14; H04L 27/26; H04W 72/0446; H04W 72/0457; H04W 72/51

(52) U.S. Cl. CPC H04W 72/1273; H04L 5/1469; H04L 27/26025; H04W 72/0446; H04W 72/0457; H04W 72/51

(57) ABSTRACT

Various example embodiments of the present disclosure relate to reporting of configured grant (CG) occasions. A terminal device obtains information on a criterion for reporting whether at least one CG occasion is to be used by the terminal device. Based on determining that the criterion is satisfied, the terminal device sends, to a network device, an indication of whether the at least one CG occasion is to be used by the terminal device. The solution for reporting CG occasions as provided in the example embodiments of the present disclosure can ensure that the indication of unused CG resources can be re-used by network, and can ensure that the resources are not re-used and UE can change the indication from cancelled to active.

### FIELD

Various example embodiments generally relate to the field of communication, and in particular, to a terminal device, a network device, methods, apparatuses and a computer readable storage medium for reporting configured grant (CG) occasions.

### BACKGROUND

Extended reality (XR) refers to all real-and-virtual combined environments and associated human-machine interactions generated by computer technology and wearables. It includes representative forms such as augmented reality (AR), mixed reality (MR), and virtual reality (VR) and the areas interpolated among them. One of the XR related video traffic characteristics in uplink (UL) is non-integer periodicity (e.g., 16.67 milliseconds for 60 frames per second).

Scheduling in UL can be realized by employing CG. For CG based scheduling, the parameters are configured via a radio resource control (RRC) message. The actual uplink grant may either be configured via RRC or provided via physical downlink control channel (PDCCH).

### SUMMARY

In general, example embodiments of the present disclosure provide a terminal device, a network device, methods, apparatuses and a computer readable storage medium for reporting unused configured grant (CG) occasions. Specifically, the example embodiments of the present disclosure can ensure that the indication of unused CG resources can be re-used by network, and can ensure that the resources are not re-used and UE can change the indication from cancelled to active.

In a first aspect, there is provided a terminal device. The terminal device may comprise one or more transceivers; and one or more processors communicatively coupled to the one or more transceivers, and the one or more processors are configured to cause the terminal device to: obtain information on a criterion for reporting whether at least one configured grant (CG) occasion is to be used by the terminal device; and based on determining that the criterion is satisfied, send, to a network device, an indication of whether the at least one CG occasion is to be used by the terminal device.

In a second aspect, there is provided a network device. The network device may comprise one or more transceivers; and one or more processors communicatively coupled to the one or more transceivers, and the one or more processors are configured to cause the network device to: determine information on a criterion for a terminal device to report whether at least one configured grant (CG) occasion is to be used by the terminal device; and send the information on the criterion to the terminal device.

In a third aspect, there is provided a method. The method may comprise: obtaining, at a terminal device, information on a criterion for reporting whether at least one configured grant (CG) occasion is to be used by the terminal device; and based on determining that the criterion is satisfied, sending, to a network device, an indication of whether the at least one CG occasion is to be used by the terminal device.

In a fourth aspect, there is provided a method. The method may comprise: determining, at a network device, information on a criterion for a terminal device to report whether at least one configured grant (CG) occasion is to be used by the terminal device; and sending the information on the criterion to the terminal device.

In a fifth aspect, there is provided an apparatus. The apparatus may comprise: means for obtaining, at a terminal device, information on a criterion for reporting whether at least one configured grant (CG) occasion is to be used by the terminal device; and means for based on determining that the criterion is satisfied, sending, to a network device, an indication of whether the at least one CG occasion is to be used by the terminal device.

In a sixth aspect, there is provided an apparatus. The apparatus may comprise: means for determining, at a network device, information on a criterion for a terminal device to report whether at least one configured grant (CG) occasion is to be used by the terminal device; and means for sending the information on the criterion to the terminal device.

In a seventh aspect, there is provided a non-transitory computer readable medium comprising program instructions for causing an apparatus to perform at least the method according to third or fourth aspect.

In an eighth aspect, there is provided a computer program comprising instructions, which, when executed by an apparatus, cause the apparatus at least to: obtain information on a criterion for reporting whether at least one configured grant (CG) occasion is to be used by the terminal device; and based on determining that the criterion is satisfied, send, to a network device, an indication of whether the at least one CG occasion is to be used by the terminal device.

In a ninth aspect, there is provided a computer program comprising instructions, which, when executed by an apparatus, cause the apparatus at least to: determine information on a criterion for a terminal device to report whether at least one configured grant (CG) occasion is to be used by the terminal device; and send the information on the criterion to the terminal device.

In a tenth aspect, there is provided a terminal device. The terminal device comprises obtaining circuitry configured to: obtain information on a criterion for reporting whether at least one configured grant (CG) occasion is to be used by the terminal device; and sending circuitry configured to based on determining that the criterion is satisfied, send, to a network device, an indication of whether the at least one CG occasion is to be used by the terminal device.

In an eleventh aspect, there is provided a network device. The network device comprises determining circuitry configured to: determine information on a criterion for a terminal device to report whether at least one configured grant (CG) occasion is to be used by the terminal device; and sending circuitry configured to: send the information on the criterion to the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example network environment in which example embodiments of the present disclosure may be implemented;

FIG. 2A illustrates an example signaling process for reporting of CG occasions according to some embodiments of the present disclosure;

FIG. 2B illustrates another example signaling process for reporting of CG occasions according to some embodiments of the present disclosure;

FIG. 3 illustrates an example configuration and behaviour of unused resources with minimum indication offset according to some embodiments of the present disclosure;

FIG. 4 illustrates an example timeline of an indication procedure together with the minimum indication offset according to some embodiments of the present disclosure;

FIG. 5 illustrates an example flowchart of a method implemented at a terminal device in accordance with some example embodiments of the present disclosure;

FIG. 6 illustrates an example flowchart of a method implemented at a network device in accordance with some example embodiments of the present disclosure;

FIG. 7 illustrates an example simplified block diagram of an apparatus that is suitable for implementing embodiments of the present disclosure; and

FIG. 8 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As discussed above, the main XR related video traffic characteristics in UL as per TR 38.838 can be summarized as follows: 1) Non-integer periodicity (e.g., 16.67 ms for 60 fps); 2) PDB requirement of 30 ms as baseline, and 10, 15 ms as optional; and 3) varying video frame size with mean 20.8 kBytes for 60 fps and 10 Mbit/s following Truncated Gaussian distribution.

In addition to video in UL, pose/control information can be sent as per technical report (TR) 38.838 with the following main characteristics: 1) periodicity of 4 ms; 2) stringent PDB requirement (10 ms); and 3) frame size of 100 bytes.

As to the CG, the main characteristics of NR Rel-16 UL CG are the following: 1) UL radio resources for sending one transport block with a regular time-periodicity is configured for a UE; 2) the periodicities are: 2, 7, n*14 symbols, where the range for n depends on configured SCS; and 3) up to 12 configured grant configurations per bandwidth part (BWP) (configured through RRC signalling).

The above mentioned CG enhancements approved for specification work in RAN #98 were motivated by large and variable video size in UL that in many cases require more than one slot to be transmitted. For certain XR applications such as Augmented Reality as per TR 38.838, there could be different traffic in UL. The different traffics are: (i) pose/control every 4 ms and (ii) video every 16.67 ms for 60 fps. The PDB for pose/control is equal to 10 ms and for UL video is 30 ms and optional is 10, 15 ms.

One of the enhancements considered for specification work is dynamic indication of unused CG occasion(s). This is especially needed when video is transmitted with CG resources and one video frame is conveyed via multiple UL slots with multiple UL CG PUSCH occasions. In that case multiple CG occasions (slots) per CG period is assumed. However, due to variable video frame size, not all CG occasions might be used in one period. In order to improve resource utilization, UE may indicate that certain CG occasions are not used. In that case, gNB can distribute the released resources to other users.

The purpose of the UE indication of unused CG occasions is to enable network to re-use those resources (for another UE or the same UE for retransmission or transmission of other data with different LCP restrictions). In order to enable the reuse of CG resources that are unused yet granted to a certain UE, two timelines need to be met.

One of the two timelines need to be met is: the network must have sufficient time to reschedule the unused CG resources (based on UE reporting). Another one of the two timelines need to be met is: the UE selected to reuse the unused resources left by another UE must have enough time to transmit its data in UL including at least PUSCH preparation time.

This means, firstly, upon receiving the indication of unused resources from a UE (or multiple UEs), network scheduler must decide how to re-allocate the unused resources indicated by one or multiple UEs. This delay depends on a network implementation (and possibly a load).

Secondly, the re-allocation of the unused UL resources needs to respect the UE processing time in order to allow sufficient time for the UE (to which the resource is allocated) to encode/form the PUSCH to be transmitted. For example, Section 6.4 of TS38.214 describes the UE processing time related requirements. When scheduling the UE, the slot offset K₂ and start of the PUSCH allocation in slot (set by S and L of ‘Time domain resource assignment’ of the scheduling DCI) and also accounting the timing advance need to be set so that the first symbol of the PUSCH cannot be earlier than symbol L₂ where L₂ is defined as symbol which Cyclic Prefix (CP) is starting T_{proc2} after the end of the DCI scheduling the PUSCH. T_{proc2} is defined as:

$${T}_{\text{?}} = max ( ( {N}_{2} + {d}_{2 , 1} + {d}_{2} ) ( 2048 + 144 ) \cdot {κ2}^{- μ} \cdot {T}_{\text{?}} + {T}_{\text{?}} + {T}_{\text{?}} , {d}_{2 , 2} )$$

$$\text{?} \text{indicates text missing or illegible when filed}$$

Where:
N₂ is based on μ of Table 6.4-1 and Table 6.4-2 in TS38.214 for UE processing capability 1 and 2 respectively, where μ corresponds to the one of (μ_{DL}, μ_{UL}) resulting with the largest T_{proc,2}, where the μ_{DL} corresponds to the subcarrier spacing of the downlink with which the PDCCH carrying the DCI scheduling the PUSCH was transmitted and μ_{UL} corresponds to the subcarrier spacing of the uplink channel with which the PUSCH is to be transmitted, and κ is defined in clause 4.1 of [4, TS 38.211].
For operation with shared spectrum channel access, Tₑₓₜ is calculated according to [4, TS 38.211], otherwise Tₑₓₜ=0.
If the first symbol of the PUSCH allocation consists of DM-RS only, then d_{2,1}=0, otherwise d_{2,1}=1.
If the UE is configured with multiple active component carriers, the first uplink symbol in the PUSCH allocation further includes the effect of timing difference between component carriers as given in [11, TS 38.133].
If the scheduling DCI triggered a switch of BWP, d_{2,2} equals to the switching time as defined in [11, TS 38.133], otherwise d_{2,2}=0.
If a PUSCH of a larger priority index would overlap with PUCCH of a smaller priority index, d₂ for the PUSCH of a larger priority is set as reported by the UE; otherwise d₂=0.
For a UE that supports capability 2 on a given cell, the processing time according to UE processing capability 2 is applied if the high layer parameter processingType2Enabled in PUSCH-ServingCellConfig is configured for the cell and set to ‘enable’,
If the PUSCH indicated by the DCI is overlapping with one or more PUCCH channels, then the transport block is multiplexed following the procedure in clause 9.2.5 of [6, TS 38.213], otherwise the transport block is transmitted on the PUSCH indicated by the DCI.
If uplink switching gap is triggered as defined in clause 6.1.6, T_{switch} equals to the switching gap duration and for the UE configured with higher layer parameter uplinkTxSwitchingOption set to ‘dualUL’ for uplink carrier aggregation μ_{UL}-min(μ_{UL,carrier1}, μ_{UL,carrier2}), otherwise T_{switch}=0.

Therefore, the present disclosure proposed a solution for reporting of CG occasions. According to embodiments of the present disclosure, a terminal device obtains information on a criterion for reporting whether at least one configured grant (CG) occasion is to be used by the terminal device. Based on determining that the criterion is satisfied, the terminal device sends, to a network device, an indication of whether the at least one CG occasion is to be used by the terminal device. It is understood that the above procedure steps may work together, in a flow of operations as described in the next section, partly together or independently of each other.

The solution for reporting of CG occasions as provided in the present disclosure introduces a prohibit duration/time to ensure that only when there is sufficient time allowing re-scheduling, a UE is allowed or enabled to report the unused CG occasions. The solution can ensure that the indication of unused CG resources can be re-used by network, and/or can ensure that the resources are not re-used and UE can change the indication from cancelled to active. Principles and some example embodiments of the present disclosure will be described in detail below with reference to the accompanying drawings.

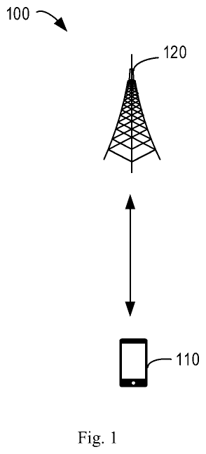

For illustrative purposes, principle and example embodiments of the present disclosure for the reporting of CG occasions will be described below with reference to FIG. 1-FIG. 8. However, it is to be noted that these embodiments are given to enable the skilled in the art to understand inventive concepts of the present disclosure and implement the solution as proposed herein, and not intended to limit scope of the present application in any way.

Reference is made to FIG. 1, which illustrates an example network environment 100A in which example embodiments of the present disclosure may be implemented. The network environment 100, which may be a part of a communication network, includes a terminal device 110 and a network device 120.

As illustrated in FIG. 1, the terminal device 110 may also be referred as a user equipment 110 or a UE 110. The network device 120 may also be referred as a gNB 120. In some example embodiments, the network device 120 may configure the terminal device 110 with UL CG resources. The network device 120 may also configure the rule for UE reporting of unused/used CG occasions, for example, the starting symbol of the unused/used resource is at least equal than the minimum offset after the last symbol of the resource for UL reporting.

In some example embodiments, once it is known that some of the configured CG occasions will not be used, the terminal device 110 reports the unused CG occasions if the timeline condition is met (assuming the timeline is configured or specified). Otherwise, the terminal device 110 does not send the indication.

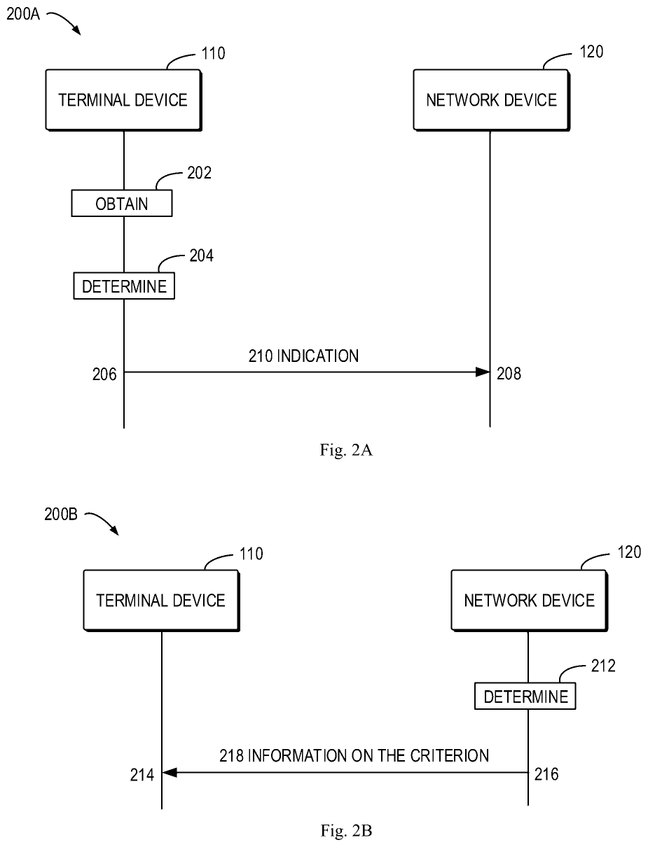

Reference is made to FIG. 2A, which illustrates an example signaling process 200A for reporting of CG occasions according to some embodiments of the present disclosure. As shown in FIG. 2A, the terminal device 110 obtains (202) information on a criterion for reporting whether at least one configured grant (CG) occasion is to be used by the terminal device 110. Based on determining (204) that the criterion is satisfied, the terminal device 110 sends (206), to the network device 120, an indication 210 of whether the at least one CG occasion is to be used by the terminal device 110. The network device 120 receives (208) the indication 210 from the terminal device 110.

In some example embodiments, the terminal device 110 may obtain the information on the criterion for reporting whether a plurality of CG occasions are to be used by the terminal device 110.

Reference is made to FIG. 2B, which illustrates an example signaling process 200B for reporting of CG occasions according to some embodiments of the present disclosure. As shown in FIG. 2B, the network device 120 determines (212), information on a criterion 218 for the terminal device 110 to report whether at least one CG occasion is to be used by the terminal device 110. The network device 120 sends (216) the information on the criterion 218 to the terminal device 110. The terminal device 110 receives (214) the information on the criterion 218.

In some example embodiments, the criterion 208 may comprise a CG occasion of the at least one CG occasion equal to or larger than a first time offset after a last symbol of an uplink (UL) channel carrying the indication 216 is allowed to be indicated as unused. In some example embodiments, the criterion 208 may comprise a closest CG occasion after a second time offset is a first CG occasion allowed to be indicated as used or unused, and the second time offset may be part of the indication 216. In some example embodiments, the criterion 208 may comprise a third time offset which tells when the indication 216 is not allowed to be changed, e.g., if the time between indication and the indicated occasion is less than a certain time offset, the changes in indication are not allowed.

By implementing FIG. 2A or FIG. 2B, a solution for reporting of CG occasions can be provided. As such, a prohibit duration/time is provided to ensure that only when there is sufficient time allowing re-scheduling, a UE is allowed or enabled to report the unused/used CG occasions. By implementation of the solution, it can ensure that the indication of unused CG resources can be re-used by network, and it can ensure that the resources are not re-used and UE can change the indication from cancelled to active.

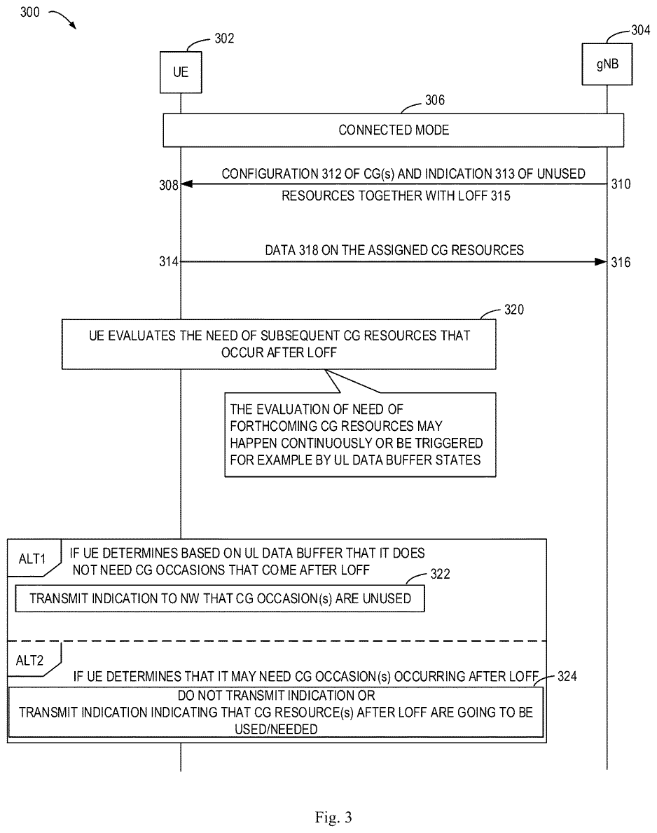

Reference is made to FIG. 3, which illustrates an example configuration and behaviour 300 of unused resources with minimum indication offset according to some embodiments of the present disclosure. It is understood that the example configuration and behaviour 300 in FIG. 3 can be considered as an example of the signaling process 200A in FIG. 2A or the signaling process 200B in FIG. 2B. Accordingly, the UE 302 in FIG. 3 is an example of the terminal device 110 in FIG. 2A or FIG. 2B. The gNB 304 in FIG. 3 is an example of the network device 120 in FIG. 2A or FIG. 2B.

In some example embodiments, the UE 302 and the gNB 304 may be connected (306). The gNB 304 may send (310) configuration 312 of CG(s) and indication 313 of unused resources together with minimum indication time (Ioff) 315. The UE 302 may receive (308) the configuration 312 and the indication 313 together with the Ioff 315.

In some example embodiments, the UE 302 may transmit (314) data 318 on the assigned CG resources. The UE 302 may evaluate (320) the need of subsequent CG resources that occur after the Ioff 315. In some example embodiments, the evaluation of need of forthcoming CG resources may happen continuously or be triggered, for example, by UL data buffer states. In some example embodiments, the evaluation of need of forthcoming CG resources may happen before the first data transmission, i.e. evaluation (320) may occur before transmission (314).

In some example embodiments, if the UE 302 determines, based on UL data buffer that it does not need CG occasions that come after the Ioff 315, the UE 302 may transmit (322) an indication to the network that CG occasion(s) are unused.

In some example embodiments, if the UE 302 determines that it may need CG occasion(s) occurring after the Ioff 315, the UE 302 may not transmit an indication. In some example embodiments, if the UE 302 determines that it may need CG occasion(s) occurring after the Ioff 315, the UE 302 may transmit (324) an indication indicating that CG resource(s) after the Ioff 315 are going to be used or needed.

In some example embodiments, the gNB 304 may configure the Ioff 315, for the indication of unused resources (e.g. reported in the UCI), so that the UE 302 may only indicate resources that are at least equal or larger than the minimum offset after the last symbol of the UL channel carrying the indication.

In some example embodiments, the gNB 304 may configure the minimum offset. The minimum offset may be part of CG indication of used/unused resources to define the start of CG indication as e.g., the closest scheduled CG occasion after the minimum offset is the first occasion that may be indicated as used/unused by UE 110 to gNB 120.

In some example embodiments, the gNB 304 may configure the minimum offset, after which the previous indication from the UE 110 may not be changed, e.g., changing the previous indication from canceled to used. In that case, the minimum offset may define a rule for gNB 304 when it may start using the resources for another UE or for other purpose.

In some example embodiments, the gNB 304 may determine the minimum offset for the indication of unused resources accounting scheduling decision processing delay (of the network). In some example embodiments, the gNB 304 may determine the minimum offset for the indication of unused resources accounting available scheduling occasions (SSset configuration(s) and DL slot pattern). In some example embodiments, the gNB 304 may determine the minimum offset for the indication of unused resources accounting the minimum offset may depend on the sub-carrier spacing of the BWP of the unused CG resources. The minimum offset may be configured per BWP, or per SCS, or scaled by the UE based on SCS. In some example embodiments, the gNB 304 may determine the minimum offset for the indication of unused resources accounting the Time Division Duplex (TDD) radio frame configuration (in case of TDD system).

In some example embodiments, the gNB 304 may determine the minimum offset for the indication of unused/used resources accounting the minimum offset Ioff may depend on the processing capabilities of the active UEs that belong to the same cell (where the processing timeline may be determined based on group of UEs e.g. worst case capability or best case capability). The minimum offset may be updated dynamically according to the status of the UEs. In some example embodiments, the gNB 304 may determine the minimum offset for the indication of unused resources accounting the minimum indication time offset may be evaluated as a function of time difference between CG resources (current, future) or CG occasions of multiple CG resources (last symbol of current CG occasion, first symbol of the evaluated CG occasion) or timing of slots (current (UL) slot versus forthcoming slot of evaluated CG resource).

In some example embodiments, the gNB 304 may determine the minimum offset for the indication of unused/used resources accounting the minimum indication offset may be determined as a minimum number of DL slots between the UL slot carrying the indication and UL slot of the CG resource. The minimum offset may be predefined based on maximum or minimum UE processing time for the SCS and/or the structure of the TDD radio frame and UL slot pattern (in case of TDD system) without network configuration.

In some example embodiments, it may be possible that the gNB 304 always requesting the UE 302 to report unused resource such that the gNB 304 may not need to detect the data over the allocated resource and the UE 302 may skip UL transmission.

In some example embodiments, the UE 302 may be provided by the gNB 304 a configuration of the minimum indication time offset as a part of the configuration of CG resource(s) and enabling the indication of unused/used resources. Based on the UL data buffer and/or expected UL traffic characteristics (e.g. size, periodicity, packet delay budget, reliability requirement, priority), the UE 302 may determine whether it will need the CG resource(s) that occur at least a certain amount of time units (e.g., symbols or slots) after the end of UL symbol/slot/transmission carrying the indication of unused resources. The UE 302 may also evaluate if the resources within Ioff are enough to carry the data in buffer. The amount of time units may be the time offset indicated by the gNB 304 or pre-configured according to processing time for SCS and TDD frame structure or it can be specified in the standards. If UE 302 determines that granted resources after the time offset are not needed, UE 302 may provide indication to NW e.g. by piggybacking an UCI together with UL data transmission.

In some example embodiments, the gNB 304 may define the closest scheduled CG occasion after the minimum offset may be the first occasion that may be indicated as used/unused by UE 302 to gNB 304.

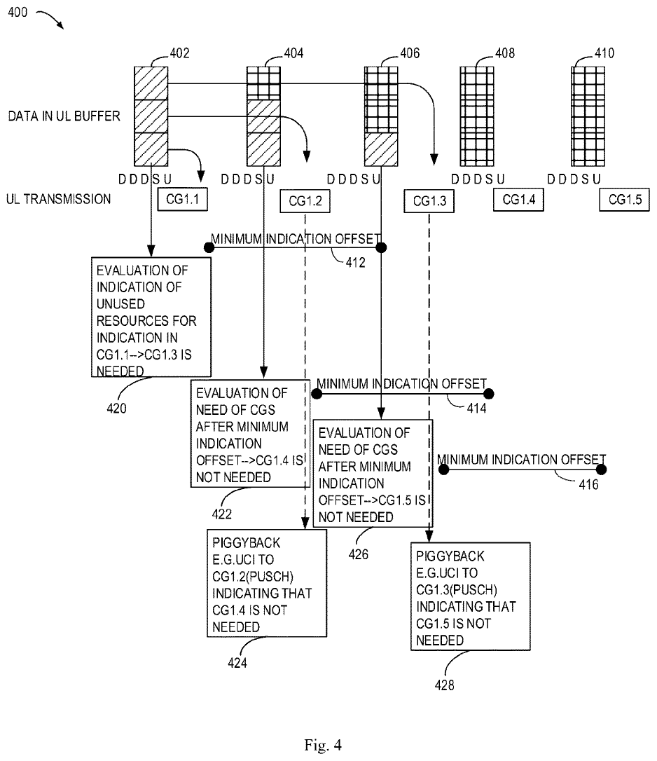

Reference is made to FIG. 4, which illustrates an example timeline 400 of an indication procedure together with the minimum indication offset according to some embodiments of the present disclosure.

In some example embodiments, for data in UL buffer 402, as shown in block 420, evaluation of indication of unused resources for indication in CG 1.1 to CG 1.3 may be needed. For data in UL buffer 404, as shown in block 422, evaluation of need of CGs after minimum indication offset 414 to CG 1.4 may not be needed.

In some example embodiments, for CG 1.2, as shown in block 424, piggyback e.g. UCI to CG 1.2 (PUSCH) indicating that CG 1.4 may not be needed. For data in UL buffer 406, as shown in block 426, evaluation of need of CGs after minimum indication offset 416 to CG 1.5 may not be needed. For CG 1.3, as shown in block 428, piggyback e.g. UCI to CG 1.3 (PUSCH) indicating that CG 1.5 may not be needed.

In some example embodiments, the network (such as the gNB 304 in FIG. 3) may identify multiple categories of UEs according to their processing capabilities and determines multiple minimum time offsets, and one time offset for each UE capability. The network may indicate the time offset to the UE of its capability. The unused CG resources indicated by a UE may be reallocated by the network to the UEs that belong to the same capability or a capability with UE having shorter time offset. In some example embodiments, the network (such as the gNB 304 in FIG. 3) may determine the same minimum time offsets which appliable to all UEs in the cell independent of UE capability.

As an example, unused resources of UEs belonging to capability 2 may be reallocated to UEs that belong to the capability 1 and capability 2 (excluding the UE that has indicated the unused resources).

In some example embodiments, the network may configure the minimum offset, Ioff, after which the previous indication from UE cannot be changed, e.g., changing the previous indication from canceled to activation. In that case, the minimum offset may define a rule for gNB when it may start using the resources for another UE.

In some example embodiments, a UE may send an indication 110. Regarding indication “110”, 1 may be for 2^{nd} (CG 1.2), 1 may be for 3^{rd} (CG 1.3), and 0 may be for 4^{th} (CG 1.4) UL, where 1 represents used slot and 0 represents unused slot. If for some reason UE will need the 4^{th} UL, then the time between UCI carrying the changes and the slot to be changed from canceled to used shall be larger than the minimum offset. In some example embodiments, a UE may also indicate if no further CG is needed for a time duration.

Reference is made to FIG. 5, which an example flowchart of a method 500 implemented at a terminal device in accordance with some example embodiments of the present disclosure. Reference will be made in combination with FIG. 1.

At 502, the terminal device 110 obtains information on a criterion for reporting whether at least one configured grant (CG) occasion is to be used by the terminal device 110. At 504, based on determining that the criterion is satisfied, the terminal device 110 sends, to the network device 120, an indication of whether the at least one CG occasion is to be used by the terminal device 110.

In some example embodiments, the criterion may comprise at least one of the following: a CG occasion of the at least one CG occasion equal to or larger than a first time offset after a last symbol of an uplink (UL) channel carrying the indication is allowed to be indicated as unused, a closest CG occasion after a second time offset is a first CG occasion allowed to be indicated as used or unused. The second time offset may be part of the indication, or a third time offset after which the indication is not allowed to be changed.

In some example embodiments, at least one of the first time offset, the second time offset, or the third time offset may be determined based on at least one of the following: an indication from the network device 120, a scheduling decision processing delay of the network device 120, an available scheduling occasion, a sub-carrier spacing (SCS) of a bandwidth part (BWP) of an unused CG resource, a processing capability of the terminal device 110, processing capabilities of active terminal devices that belong to a cell, a function of a time difference between CG resources, CG occasions of multiple CG resources, or timing of slots, a minimum number of downlink (DL) slots between a UL slot carrying the indication and a UL slot of the at least one CG resource, or a maximum or minimum processing time of the terminal device 110 for the SCS or a structure of a time division duplexing (TDD) radio frame and a UL slot pattern without a network device configuration.

In some example embodiments, at least one of the first time offset, the second time offset, or the third time offset may be configured per BWP, per SCS, or scaled by the terminal device 110 based on a SCS.

In some example embodiments, the terminal device 110 may, based on determining that the criterion is satisfied for the CG occasion, evaluate a need for the CG occasion based on at least one of a UL data buffer or a UL traffic characteristic.

In some example embodiments, the terminal device 110 may send the indication by at least one of the following: based on determining that the terminal device 110 does not need the at least one CG occasion, sending the indication to indicate that the at least a CG occasion is not to be used by the terminal device 110; or based on determining that the terminal device 110 needs the CG occasion, sending the indication to indicate that the CG occasion is to be used by the terminal device 110.

In some example embodiments, the evaluation of the need for the at least a CG occasion may be performed continuously or triggered by a UL data buffer state. In some example embodiments, at least one of the first time offset, the second time offset, or the third time offset may apply to a capability of terminal devices, and the terminal device 110 may belong to the capability of terminal devices.

In some example embodiments, at least one of the first time offset, the second time offset, or the third time offset may apply to a plurality of terminal devices served by the network device.

In some example embodiments, the terminal device 110 may be a first terminal device and the capability of terminal devices may be a first capability of terminal devices. In some example embodiments, an unused CG occasion indicated by the first terminal device may be rescheduled by the network device 120 to a second terminal device. In some example embodiments, the second terminal device may belong to the first capability of terminal devices or a second capability of terminal devices having a shorter time offset than the first capability of terminal devices.

In some example embodiments, the terminal device 110 may obtain the information on the criterion by receiving the information on the criterion from the network device 120. In some example embodiments, the terminal device 110 may, based on determining that the criterion is not satisfied, skip sending the indication to the network device 120.

In some example embodiments, the terminal device 110 may determine a first CG occasion which satisfies the criterion as the first CG occasion; and the terminal device 110 may send, to the network device 120, an indication indicating the first CG occasion is to be used by the terminal device 110.

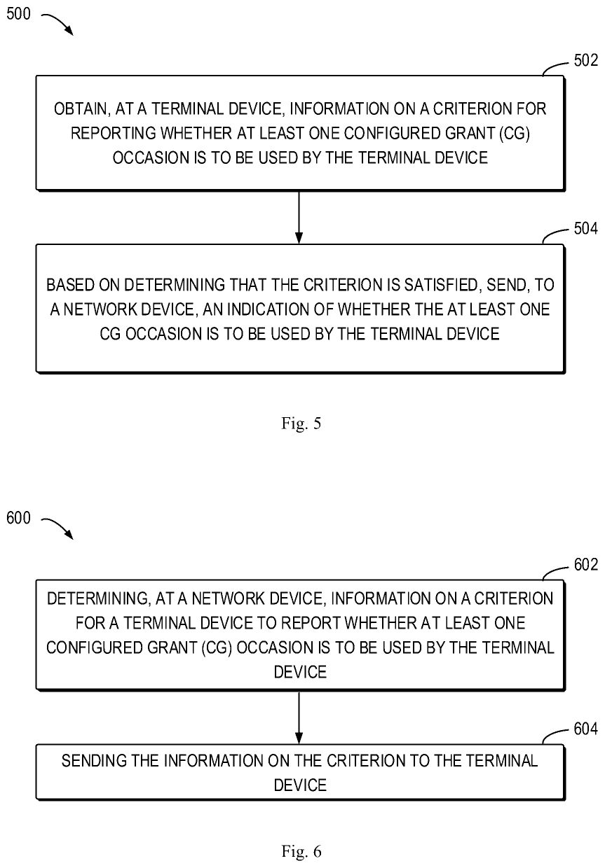

Reference is made to FIG. 6, which illustrates an example flowchart of a method 600 implemented at a network device in accordance with some example embodiments of the present disclosure. Reference will be made in combination with FIG. 1.

At 602, the network device 120 determines information on a criterion for a terminal device 110 to report whether at least one configured grant (CG) occasion is to be used by the terminal device 110. At 604, the network device 130 sends the information on the criterion to the terminal device 110.

In some example embodiments, the criterion may comprise at least one of the following: a CG occasion of the at least one CG occasion equal to or larger than a first time offset after a last symbol of an uplink (UL) channel carrying the indication is allowed to be indicated as unused, a closest CG occasion after a second time offset is a first CG occasion allowed to be indicated as used or unused. The second time offset may be part of the indication, or a third time offset after which the indication is not allowed to be changed.

In some example embodiments, at least one of the first time offset, the second time offset, or the third time offset may be determined based on at least one of the following: an indication from the network device 120, a scheduling decision processing delay of the network device 120, an available scheduling occasion, a sub-carrier spacing (SCS) of a bandwidth part (BWP) of an unused CG resource, a processing capability of the terminal device 110, processing capabilities of active terminal devices that belong to a cell, a function of a time difference between CG resources, CG occasions of multiple CG resources, or timing of slots, a minimum number of downlink (DL) slots between a UL slot carrying the indication and a UL slot of the at least one CG resource, or a maximum processing time of the terminal device 110 for the SCS or a structure of a time division duplexing (TDD) radio frame and a UL slot pattern without a network device configuration.

In some example embodiments, at least one of the first time offset, the second time offset, or the third time offset may be configured per BWP, per SCS, or scaled by the terminal device 110 based on a SCS.

In some example embodiments, the network device 120 may determine the information on the criterion by identifying a capability of terminal devices based on processing capabilities of the terminal devices. The terminal device 110 may belong to the capability of terminal devices; and the network device 120 may determine the the information on criterion by determining the information on the criterion for the capability of terminal devices.

In some example embodiments, the terminal device 110 may be a first terminal device. In some example embodiments, the network device 120 may receive, from the first terminal device, an indication that a CG occasion is not to be used by the first terminal device; and reschedule the CG occasion to a second terminal device.

In some example embodiments, the terminal device 110 may be a first terminal device and the capability of terminal devices may be a first capability of terminal devices. In some example embodiments, the second terminal device may belong to the first capability of terminal devices or a second capability of terminal devices having a shorter time offset than the first capability of terminal devices.

By implementing the methods 500 and 600, a prohibit duration/time is introduced to ensure that only when there is sufficient time allowing re-scheduling, a UE is allowed/enabled to report the unused CG occasions. The methods can ensure that the indication of unused CG resources can be re-used by network, and can ensure that the resources are not re-used and UE can change the indication from cancelled to active.

In some example embodiments, an apparatus of a terminal device capable of performing the method 500 may comprise means for performing the respective steps of the method 500. The means may be implemented in any suitable form. For example, the means may be implemented in a circuitry or software module.

In some example embodiments, the apparatus may comprise means for obtaining information on a criterion for reporting whether a configured grant (CG) occasion is to be used by the terminal device; and means for sending, based on determining that the criterion is satisfied and to a network device, an indication of whether the CG occasion is to be used by the terminal device.

In some example embodiments, the criterion may comprise at least one of the following: a CG occasion of the at least one CG occasion equal to or larger than a first time offset after a last symbol of an uplink (UL) channel carrying the indication is allowed to be indicated as unused, a closest CG occasion after a second time offset is a first CG occasion allowed to be indicated as used or unused, wherein the second time offset is part of the indication, or a third time offset after which the indication is not allowed to be changed.

In some example embodiments, the means for determining the criterion may comprise means for determining at least one of the first time offset, the second time offset, or the third time offset based on at least one of the following: an indication from the network device, a scheduling decision processing delay of the network device, an available scheduling occasion, a sub-carrier spacing (SCS) of a bandwidth part (BWP) of an unused CG resource, a processing capability of the terminal device, processing capabilities of active terminal devices that belong to a cell, a function of a time difference between CG resources, CG occasions of multiple CG resources, or timing of slots, a minimum number of downlink (DL) slots between a UL slot carrying the indication and a UL slot of the at least one CG resource, or a maximum processing time of the terminal device for the SCS or a structure of a time division duplexing (TDD) radio frame and a UL slot pattern without a network device configuration.

In some example embodiments, the apparatus may comprise means for configuring at least one of the first time offset, the second time offset, or the third time offset per BWP, per SCS, or scaled by the terminal device based on a SCS.

In some example embodiments, the apparatus may comprise means for evaluating, based on determining that the criterion is satisfied for the CG occasion, a need for the CG occasion based on at least one of a UL data buffer or a UL traffic characteristic.

In some example embodiments, the means for sending the indication may comprise means for sending the indication by at least one of the following: based on determining that the terminal device does not need the CG occasion, sending the indication to indicate that the CG occasion is to not be used by the terminal device; or based on determining that the terminal device needs the CG occasion, sending the indication to indicate that the CG occasion is to be used by the terminal device.

In some example embodiments, the means for evaluating the need for the CG occasion may comprise means for performing the evaluation of the need for the CG occasion continuously, or means for triggering the evaluation of the need for the CG occasion by a UL data buffer state.

In some example embodiments, the apparatus may comprise means for applying at least one of the first time offset, the second time offset, or the third time offset to a capability of terminal devices. In some example embodiments, the terminal device may belong to the capability of terminal devices.

In some example embodiments, the terminal device may be a first terminal device and the capability of terminal devices may be a first capability of terminal devices. In some example embodiments, the apparatus may comprise means for rescheduling an unused CG occasion indicated by the first terminal device by the network device to a second terminal device. In some example embodiments, the second terminal device may belong to the first capability of terminal devices or a second capability of terminal devices having a shorter time offset than the first capability of terminal devices.

In some example embodiments, the means for obtaining the information on the criterion may comprise means for obtaining the information on the criterion by receiving the information on the criterion from the network device. In some example embodiments, the apparatus may comprise means for skipping sending, based on determining that the criterion is not satisfied, the indication to the network device.

In some example embodiments, the apparatus may comprise means for determining a first CG occasion which satisfies the criterion as the first CG occasion; and means for sending, to the network device, an indication indicating the first CG occasion is to be used by the terminal device.

In some example embodiments, the apparatus further comprises means for performing other steps in some example embodiments of the method 500. In some example embodiments, the means comprises at least one processor and at least one memory including computer program code, the at least one memory and computer program code configured to, with the at least one processor, cause the performance of the apparatus.

In some example embodiments, an apparatus of a network device capable of performing the method 600 may comprise means for performing the respective steps of the method 600. The means may be implemented in any suitable form. For example, the means may be implemented in a circuitry or software module.

In some example embodiments, the apparatus may comprise means for determining information on a criterion for a terminal device to report whether a configured grant (CG) occasion is to be used by the terminal device; and means for sending the information on the criterion to the terminal device.

In some example embodiments, the criterion may comprise at least one of the following: a CG occasion of the at least one CG occasion equal to or larger than a first time offset after a last symbol of an uplink (UL) channel carrying the indication is allowed to be indicated as unused, a closest CG occasion after a second time offset is a first CG occasion allowed to be indicated as used or unused, wherein the second time offset is part of the indication, or a third time offset after which the indication is not allowed to be changed.

In some example embodiments, the means for determining the information on the criterion may comprise means for determining at least one of the first time offset, the second time offset, or the third time offset based on at least one of the following: an indication from the network device, a scheduling decision processing delay of the network device, an available scheduling occasion, a sub-carrier spacing (SCS) of a bandwidth part (BWP) of an unused CG resource, a processing capability of the terminal device, processing capabilities of active terminal devices that belong to a cell, a function of a time difference between CG resources, CG occasions of multiple CG resources, or timing of slots, a minimum number of downlink (DL) slots between a UL slot carrying the indication and a UL slot of the at least one CG resource, or a maximum processing time of the terminal device for the SCS or a structure of a time division duplexing (TDD) radio frame and a UL slot pattern without a network device configuration.

In some example embodiments, the apparatus may comprise means for configuring at least one of the first time offset, the second time offset, or the third time offset per BWP, per SCS, or scaled by the terminal device based on a SCS.

In some example embodiments, the means for determining the information on the criterion may comprise means for identifying a capability of terminal devices based on processing capabilities of the terminal devices, wherein the terminal device belongs to the capability of terminal devices; and means for determining the information on the criterion for the capability of terminal devices.

In some example embodiments, at least one of the first time offset, the second time offset, or the third time offset may apply to a plurality of terminal devices served by the network device.

In some example embodiments, the terminal device may be a first terminal device. In some example embodiments, the apparatus may comprise means for receiving, from the first terminal device, an indication that a CG occasion is not to be used by the first terminal device; and means for rescheduling the CG occasion to a second terminal device.

In some example embodiments, the terminal device may be a first terminal device and the capability of terminal devices may be a first capability of terminal devices. In some example embodiments, the second terminal device may belong to the first capability of terminal devices or a second capability of terminal devices having a shorter time offset than the first capability of terminal devices.

In some example embodiments, the apparatus further comprises means for performing other steps in some example embodiments of the method 600. In some example embodiments, the means comprises at least one processor and at least one memory including computer program code, the at least one memory and computer program code configured to, with the at least one processor, cause the performance of the apparatus.

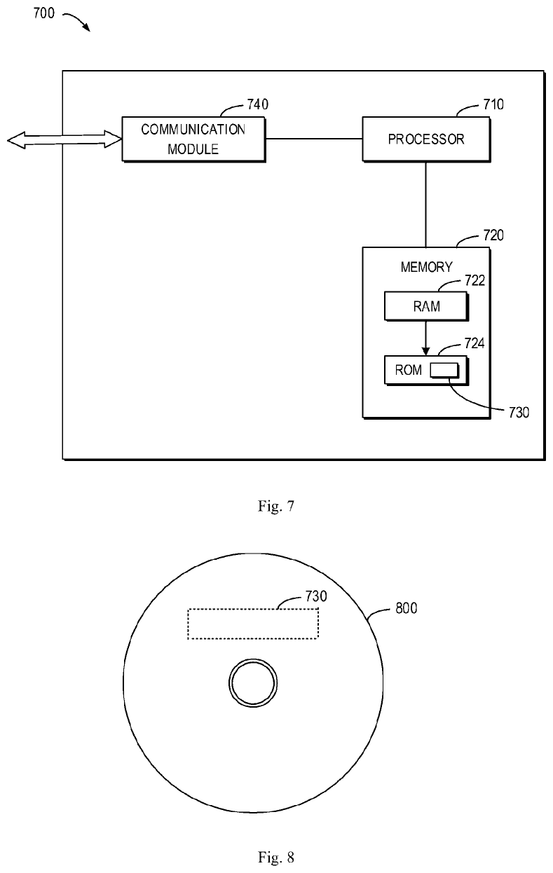

Reference is made to FIG. 7, which illustrates an example simplified block diagram of an apparatus that is suitable for implementing embodiments of the present disclosure. The device 700 may be provided to implement the communication device, for example the terminal device 110 as shown in FIG. 1. As shown, the device 700 includes one or more processors 710, one or more memories 740 may couple to the processor 710, and one or more communication modules 740 may couple to the processor 710.

The communication module 740 is for bidirectional communications. The communication module 740 has at least one antenna to facilitate communication. The communication interface may represent any interface that is necessary for communication with other network elements, for example the communication interface may be wireless or wireline to other network elements, or software based interface for communication.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program so that the device 700 may perform any process of the disclosure as discussed with reference to FIG. 2A to FIG. 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 or 600 as described above with reference to FIG. 5 or FIG. 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
obtain information on a criterion for reporting whether at least one configured grant (CG) occasion is to be used by the terminal device; and
based on determining that the criterion is satisfied, send, to a network device, an indication of whether the at least one CG occasion is to be used by the terminal device.

2. The terminal device of claim 1, wherein the criterion comprises at least one of the following:
a CG occasion of the at least one CG occasion equal to or larger than a first time offset after a last symbol of an uplink (UL) channel carrying the indication is allowed to be indicated as unused;
a closest CG occasion after a second time offset is a first CG occasion allowed to be indicated as used or unused, wherein the second time offset is part of the indication; or
the indication is not allowed to be changed after a third time offset.

3. The terminal device of claim 2, wherein at least one of the first time offset, the second time offset, or the third time offset is determined based on at least one of the following:
an indication from the network device;
a scheduling decision processing delay of the network device;
an available scheduling occasion;
a sub-carrier spacing (SCS) of a bandwidth part (BWP) of an unused CG resource;
a processing capability of the terminal device;
processing capabilities of active terminal devices that belong to a cell;
a function of a time difference between CG resources, CG occasions of multiple CG resources, or timing of slots;
a minimum number of downlink (DL) slots between a UL slot carrying the indication and a UL slot of the at least one CG resource; or
a maximum processing time of the terminal device for the SCS or a structure of a time division duplexing (TDD) radio frame and a UL slot pattern without a network device configuration.

4. The terminal device of claim 2, wherein at least one of the first time offset, the second time offset, or the third time offset is configured per BWP, per SCS, or scaled by the terminal device based on a SCS.

5. The terminal device of claim 1, wherein the terminal device is further caused to:
based on determining that the criterion is satisfied for the at least one CG occasion, evaluate a need for the at least one CG occasion based on at least one of a UL data buffer or a UL traffic characteristic.

6. The terminal device of claim 5, wherein the terminal device is caused to send the indication by at least one of the following:
based on determining that the terminal device does not need the at least one CG occasion, sending the indication to indicate that the at least one CG occasion is to not be used by the terminal device; or
based on determining that the terminal device needs the at least one CG occasion, sending the indication to indicate that the at least one CG occasion is to be used by the terminal device.

7. The terminal device of claim 5, wherein the evaluation of the need for the at least one CG occasion is performed continuously or triggered by a UL data buffer state.

8. The terminal device of claim 2, wherein at least one of the first time offset, the second time offset, or the third time offset applies to a capability of terminal devices, and the terminal device belongs to the capability of terminal devices.

9. The terminal device of claim 2, wherein at least one of the first time offset, the second time offset, or the third time offset applies to a plurality of terminal devices served by the network device.

10. The terminal device of claim 8, wherein:
the terminal device is a first terminal device and the capability of terminal devices is a first capability of terminal devices;
an unused CG occasion indicated by the first terminal device is rescheduled by the network device to a second terminal device; and
the second terminal device belongs to the first capability of terminal devices or a second capability of terminal devices having a shorter time offset than the first capability of terminal devices.

11. The terminal device of claim 1, wherein the terminal device is caused to obtain the information on the criterion by:
receiving the information on the criterion from the network device.

12. The terminal device of claim 1, wherein the terminal device is further caused to:
based on determining that the criterion is not satisfied, skip sending the indication to the network device.

13. The terminal device of claim 1, wherein the terminal device is further caused to:
determine a first CG occasion which satisfies the criterion as the first CG occasion; and
send, to the network device, an indication indicating the first CG occasion is to be used by the terminal device.

14. A network device comprising:
at least one processor; and
at least one memory storing instructions that, when executed by the at least one processor, cause the network device at least to:
determine information on a criterion for a terminal device to report whether at least one configured grant (CG) occasion is to be used by the terminal device; and
send the information on the criterion to the terminal device.

15. The network device of claim 14, wherein the criterion comprises at least one of the following:
a CG occasion of at least one occasion equal to or larger than a first time offset after a last symbol of an uplink (UL) channel carrying the indication is allowed to be indicated as unused;
a closest CG occasion after a second time offset is a first CG occasion allowed to be indicated as used or unused, wherein the second time offset is part of the indication; or
the indication is not allowed to be changed after a third time offset.

16. The network device of claim 14, wherein at least one of the first time offset, the second time offset, or the third time offset is determined based on at least one of the following:
an indication from the network device;
a scheduling decision processing delay of the network device;
an available scheduling occasion;
a sub-carrier spacing (SCS) of a bandwidth part (BWP) of an unused CG resource;
a processing capability of the terminal device;
processing capabilities of active terminal devices that belong to a cell;
a function of a time difference between CG resources, CG occasions of multiple CG resources, or timing of slots;
a minimum number of downlink (DL) slots between a UL slot carrying the indication and a UL slot of the at least one CG resource; or
a maximum processing time of the terminal device for the SCS or a structure of a time division duplexing (TDD) radio frame and a UL slot pattern without a network device configuration.

17. The network device of claim 15, wherein at least one of the first time offset, the second time offset, or the third time offset is configured per BWP, per SCS, or scaled by the terminal device based on a SCS.

18. The network device of claim 14, wherein the network device is caused to determine the criterion by:
identifying a capability of terminal devices based on processing capabilities of the terminal devices, wherein the terminal device belongs to the capability of terminal devices; and
determining the criterion for the capability of terminal devices.

19. The network device of claim 14, wherein the terminal device is a first terminal device, and the network device is further caused to:
receive, from the first terminal device, an indication that a CG occasion is not to be used by the first terminal device; and
reschedule the at least one CG occasion to a second terminal device.

20. (canceled)

21. A method comprising:
obtaining, at a terminal device, information on a criterion for reporting whether at least one configured grant (CG) occasion is to be used by the terminal device; and
based on determining that the criterion is satisfied, sending, to a network device, an indication of whether the at least one CG occasion is to be used by the terminal device.

22. (canceled)

23. (canceled)
